(19) United States
(12) Patent Application Publication
(10) Pub. No.: US 2026/0115670 A1
(43) Pub. Date: Apr. 30, 2026

(54) A METHOD FOR PREPARING SUPPORTED MOF MEMBRANES INDUCED BY LOW-CRYSTAL AGGREGATED STATE STRUCTURES, MOF MEMBRANES AND THEIR APPLICATIONS

(71) Applicant: NANJING TECH UNIVERSITY, Nanjing, Jiangsu (CN)

(72) Inventors: Yichang PAN, Nanjing, Jiangsu (CN); Jingxian HUA, Nanjing, Jiangsu (CN); Zemin LI, Nanjing, Jiangsu (CN); Lixiong ZHANG, Nanjing, Jiangsu (CN); Weihong XING, Nanjing, Jiangsu (CN)

(21) Appl. No.: 19/165,708

(22) PCT Filed: Nov. 8, 2024
(86) PCT No.: PCT/CN2024/130863

§ 371 Date: Sep. 16, 2025

(30) Foreign Application Priority Data
Aug. 6, 2024 (CN) 202411069525.0

(51) Int. Cl. B01D 71/02; B01D 67/00; B01D 69/12

(52) U.S. Cl. CPC B01D 71/028; B01D 67/0051; B01D 69/1218; B01D 2323/081; B01D 2325/02833; B01D 2325/02834; B01D 2325/52

(57) ABSTRACT

The present invention relates to a method for preparing a supported MOF membrane induced by a low-crystal aggregation structure, as well as the MOF membrane and applications thereof. The preparation method includes the following steps: 1) depositing Al-MOF seeds on the surface of a porous support to obtain an Al-MOF seed layer; 2) placing the porous support with the deposited Al-MOF seed layer on its surface in a supersaturated solution for reaction, so as to grow a continuous low-crystal Al-MOF aggregate layer on the surface of the porous support; 3) performing a crystallization reaction on the porous support with the continuous low-crystal Al-MOF aggregate layer grown on its surface to obtain the Al-MOF membrane material; the supersaturated solution includes aluminum salt, ligand and coordination regulator. This method can prepare dense high-valence metal MOF crystal membrane materials, which can be used for efficient separation in various molecular-scale separation systems.

### CROSS-REFERENCE TO RELATED APPLICATIONS

This application is U.S. national phase under 35 U.S. C. § 371 of International Patent Application No. PCT/CN2024/130863, filed on Nov. 8, 2024, which claims priority to Chinese Application No. 202411069525.0, filed on Aug. 6, 2024, the contents of all of which are incorporated by reference in their entirety.

### THE FIELD OF TECHNOLOGY

The present invention specifically relates to a method for inducing the preparation of supporting MOF membranes with low-crystal aggregated state structures, MOF membranes and their applications.

### TECHNICAL BACKGROUND

Separation processes at the sub-nanoscale, including the selective transport and separation of gases, liquids, etc., play a crucial role in systems such as catalysis, energy, and material conversion. Traditional separation technologies like distillation and absorption involve complex operations and have high energy consumption and carbon emission intensity. In contrast, membrane separation technology is green, safe, and efficient. Moreover, membrane separation is not limited by thermodynamic equilibrium, and it boasts advantages such as reduced investment and operating costs, energy and consumption conservation, and process intensification brought about by integration effects.

Membrane materials are the core of membrane separation technology. Polymer membrane materials have promoted the development of membrane technology application systems from the micron scale to the nanoscale. However, in response to the demand for molecular separation at the sub-nanoscale, existing commercialized polymer membrane materials, due to the limitations of their structures, fail to meet the requirements of industrial applications in terms of separation precision, which to a large extent restricts their research and application in the field of molecular-scale separation membranes.

Metal-organic frameworks (MOFs) are a new type of porous crystalline materials formed by the coordination assembly of metal ions or ion clusters with organic ligands. Compared with traditional zeolite molecular sieve materials, MOFs not only have regular and continuous nanochannels, but more specifically, their pore sizes can be designed and precisely adjusted at the sub-nanoscale.

High-stability MOFs, formed by the coordination of high-valence metal cations with carboxylic acid-based organic ligands, exhibit exceptional thermal, chemical, and mechanical stability. MOF membranes meticulously constructed from such materials are anticipated to meet the precise and stable separation demands of molecular-scale separation systems. However, existing technologies predominantly focus on low-valence MOF materials (e.g., divalent ones), with Al-MOFs being the most prevalent. In contrast, high-valence metal MOF materials (such as trivalent ones like Al-MOFs) remain relatively scarce. This scarcity may stem from the tendency of Al-based MOF seeds to grow into rod-like structures, with uneven growth rates along different axes—making it difficult to form dense MOF membranes. Specifically, high-valence MOF crystals (e.g., Al-MOFs) feature high nucleation energy barriers, which complicates the precise control and balancing of MOF nucleation rates and growth directions. Moreover, their topological morphology is dominated by anisotropic rod-like crystals, hindering crystal intergrowth and inevitably causing grain boundary defects. These defects significantly compromise the intrinsic separation performance of the membrane materials.

Therefore, preparing high-valence MOF membranes using current technologies remains challenging. The poor grain boundary intergrowth of the membranes and the resulting grain boundary defects restrict the intrinsic separation performance of MOF channels. Moreover, the synergistic regulation of the channel orientation in MOF membranes is even more difficult to achieve, leaving room for further improvement in membrane separation performance.

### INVENTION CONTENT

The objective of the present invention is to provide a method for preparing supported MOF membranes through induction of a low-crystallinity aggregated structure. This method enables the preparation of dense high-valence metal MOF crystalline membrane materials, which can be used for efficient separation in various molecular-scale separation systems.

To achieve the above-mentioned objectives, the technical solution adopted by the present invention is:

A method for preparing an Al-MOF membrane material, which comprises the following steps: 1) depositing Al-MOF seeds on the surface of a porous support to obtain an Al-MOF seed layer; 2) placing the porous support with the deposited Al-MOF seed layer on its surface into a supersaturated solution for reaction, so as to grow a continuous low-crystallinity Al-MOF aggregate layer on the surface of the porous support; 3) performing a crystallization reaction on the porous support with the continuous low-crystallinity Al-MOF aggregate layer grown on its surface to obtain the Al-MOF membrane material; the supersaturated solution includes an aluminum salt, a ligand and a coordination regulator.

In the present invention, a supersaturated solution refers to a solution in which the amount of solute exceeds its saturated solubility. For example, in the aforementioned supersaturated solution, the dissolved amounts of the aluminum salt, ligand, and ligand regulator exceed their respective saturated solubilities.

In the existing technology, MOF membrane materials are mostly divalent MOF materials, such as Zn-MOF materials. During the crystal formation of divalent MOF materials, it is easy to control their nucleation rate and crystal growth direction, and it is easy to make the growth rates in various directions almost the same, thereby easily obtaining spherical crystal nuclei. The spherical crystal nuclei continue to grow, and it is easy to form a continuous MOF membrane. However, for trivalent and other high-valence MOF materials such as Al-MOF materials, their nucleation energy barriers are relatively high, making it difficult to precisely control and balance the nucleation rate and growth direction of MOFs. Moreover, their topological morphology is mostly dominated by anisotropic rod-like crystals, which leads to difficulties in crystal growth and intergrowth, making it hard to form a continuous and dense membrane. This causes the membrane material to be prone to defects, which in turn significantly affects its separation performance.

Through research, the inventors of the present application have found that by first depositing a seed layer on a porous carrier, the method proposed herein then leverages the principle of supersaturated crystallization to induce the seeds to first grow into a continuous low-crystalline aggregate layer. Subsequently, through the further crystallization of this low-crystalline aggregate, the transformation from a “continuous low-crystalline film to a continuous MOF crystalline film” is achieved, making it possible to prepare dense, defect-free MOF membranes. These two reaction steps correspond to the nucleation and growth of crystals, enabling highly controllable crystallization and growth behavior of MOFs and thus facilitating the preparation of high-performance MOF membranes.

In existing technologies, for divalent MOF materials, although the seed growth method is usually adopted to synthesize MOF membranes, the pre-coated or deposited seeds are in a dispersed state rather than a continuous state. That is to say, the seed method in existing technologies involves one-step growth into a continuous final MOF membrane, without involving the transitional form of the low-crystalline aggregate layer as in the present application. Using the traditional seed growth method, it is impossible to prepare a continuous and dense membrane layer of high-valence MOFs.

In some embodiments, the aluminum salt is selected from one or a combination of more than one of aluminum nitrate, aluminum isopropoxide, sodium metaaluminate, aluminum chloride, aluminum acetate, polyaluminum chloride, and aluminum sulfate octadecahydrate.

In some embodiments, the ligand is a carboxylic acid-based ligand.

In some embodiments, the ligand is selected from one or a combination of more than one of 4,4′,4″-(phenyl-1,3,5-trioxo)-benzoic acid, 1,4-benzenedicarboxylic acid, isophthalic acid, 2,5-furandicarboxylic acid, 2,5-pyrroledicarboxylic acid, and fumaric acid.

In some embodiments, the coordination regulator is selected from an acidic coordination regulator or a basic coordination regulator.

In some embodiments, the acidic coordination regulator is selected from one or a combination of more than one of formic acid, acetic acid, benzoic acid, and o-fluorobenzoic acid.

In some embodiments, the basic coordination regulator is selected from one or a combination of more than one of sodium hydroxide, sodium formate, and sodium acetate.

In some embodiments, the total mass of the aluminum salt and the ligand accounts for 4% to 20% of the mass of the supersaturated solution.

In some embodiments, the mass ratio of the aluminum salt to the ligand in the supersaturated solution is 1:1 to 1:1.5.

In some embodiments, the mass of the coordination regulator accounts for 1% to 5% of the mass of the supersaturated solution.

In some embodiments, the solvent of the supersaturated solution is selected from one or a combination of two of DMF and water. In some embodiments, the solvent of the supersaturated solution is a mixture of DMF and water. In some embodiments, the volume ratio of DMF to water in the mixture is 3:1 to 3:1.5.

In some embodiments, the preparation method further includes a step of preparing the supersaturated solution: dissolving the aluminum salt in a solvent, adding the ligand and the coordination regulator to the solvent, and stirring at room temperature to obtain the supersaturated solution.

In some embodiments, the stirring is mechanical stirring.

In some embodiments, the stirring is for 5 to 10 minutes.

In some embodiments, the thickness of the low-crystalline Al-MOF aggregate layer is 1 to 3 μm.

In some embodiments, the morphology of the low-crystalline Al-MOF aggregate layer is continuous small hill-like.

In some embodiments, the reaction in step 2) is carried out at 80 to 150° C.

In some implementations, the reaction time in step 2) is 0.5 to 2 hours.

In some embodiments, the reaction in step 2) takes place in a closed reactor. In some embodiments, the closed reactor is a polytetrafluoroethylene reactor.

In some embodiments, the crystallization reaction in step 3) is carried out at 80 to 150° C.

In some embodiments, the crystallization reaction time in step 3) is 3 to 10 hours.

In some embodiments, the crystallization reaction in step 3) takes place in a closed reactor. In some embodiments, the closed reactor is a polytetrafluoroethylene reactor.

In some embodiments, the Al-MOF seed is the same as the Al-MOF crystal in the Al-MOF membrane material, or the topological structure of the Al-MOF seed is the same as that of the Al-MOF crystal in the Al-MOF membrane material. That is, the seed crystal can be a homologous structure seed crystal, and be of the same material as the MOF film prepared subsequently. It can also be a MOF crystal with a heterogeneous structure, which has the same topology and metal salt as the MOF film prepared subsequently but with different ligands. Take the MIL-160 membrane as an example. The homologous crystal species is MIL-160 nanocrystals, and the heterologous phase crystals include CAU-10-R and KMF-1, etc.

In some embodiments, the particle size of the AL-MOF seed is 50 to 300 nm.

In some embodiments, the deposition in step 1) is achieved by hot drop coating, spin coating, vacuum filtration or sliding coating, wherein the hot drop coating includes a step of preheating the porous support and a drop coating step.

Further, during preheating, the porous support body is heated to 80 to 100° C.

Furthermore, when using the hot drop coating method or spin coating method, the seed dispersion is dropped or spun onto the surface of the support.

Furthermore, the mass concentration of the seed in the seed dispersion is 0.01 to 0.015 wt. %.

In some embodiments, the thickness of the AL-MOF seed layer is 0.5 to 5 μm.

In some embodiments, the Al-MOF seeds are prepared by one or a combination of solvothermal method and mechanical ball milling. The mechanical ball milling method can further reduce the particle size of the seeds, making it easy to reach the nanometer level. For the specific preparation method, reference can be made to the literature (J. Am. Chem. Soc., 2020, 142, 6925-6929).

In some embodiments, the preparation method further includes the steps of polishing or ultrasonically cleaning the porous support, followed by drying, before depositing the Al-MOF seeds.

Further, the drying is vacuum drying, and in some embodiments, the temperature of the vacuum drying is 150-200° C.

Further, sandpaper is used for polishing. The particle size of the sandpaper can be 600-1200 mesh.

Further, the polishing time is 5 to 10 minutes.

Further, the ultrasonic cleaning time is 10-30 minutes, and the frequency is 50-120 KHz.

In some embodiments, the porous support is selected from a porous alumina carrier or a porous polymer support.

In some embodiments, the pore size of the porous alumina carrier is 100-300 nm.

In some embodiments, the porous alumina carrier is in the form of a plate, tube, or hollow fiber.

In some embodiments, the porous alumina carrier is unmodified or modified to have a lipophilic surface.

In some embodiments, the material of the porous polymer support is selected from nylon, polyacrylonitrile, polydimethylsiloxane, polyethersulfone, or polyvinylidene fluoride.

In some embodiments, the Al-MOF is selected from one or a combination of more than one of Al-bttotb, MIL-53, CAU-10-R, CAU-23, MIL-160, KMF-1, and Al-fum.

The present invention also provides an Al-MOF membrane material prepared by the above preparation method.

The present invention also provides the use of the above-mentioned Al-MOF membrane material for the separation of carbon dioxide/methane, carbon dioxide/nitrogen, ethylene/ethane, hexane isomers, cyclohexanol/cyclohexanone, xylene isomers, and acetic acid/water. Among them, carbon dioxide/methane, carbon dioxide/nitrogen, and propylene/propane are gas separations, while hexane isomers, cyclohexanol/cyclohexanone, xylene isomers, and acetic acid/water are liquid separations.

The present invention also provides a membrane module for separation, which includes the aforementioned Al-MOF membrane material and a stainless steel support.

The assembly and preparation methods of the membrane module for separation all adopt existing conventional methods.

Due to the application of the above technical solutions, the present invention has the following advantages compared with the prior art:

(1) The present invention utilizes the transformation and growth of a continuous low-crystalline aggregate layer into a dense Al-MOF membrane layer, which is significantly different from the most common seed-secondary growth method. The latter relies on the independent growth of individual seeds to prepare a continuous MOF membrane. The continuous layer-to-continuous layer transformation of the present invention cleverly avoids the problem of non-symbiotic grain boundaries when individual seeds grow independently into a membrane, reduces the difficulty of preparing dense MOF membranes, and realizes the universal preparation of high-valence MOF membranes such as Al-MOF. In addition, the transformation of this membrane preparation method also weakens the influence of the support structure on membrane preparation to a certain extent, so that the separation performance of the MOF membrane is not limited by the configuration and material of the support, which significantly improves the application potential of MOF materials and membranes.

(2) The Al-MOF material prepared by the present invention is a high-valence MOF material with excellent structural stability, including water, thermal, chemical and mechanical stability, etc. The membrane material has excellent separation performance and operational stability in molecular separation systems.

### DESCRIPTION OF THE DRAWINGS

FIG. 1 shows the SEM image of the low-crystalline MOF aggregate layer prepared in Example 1;

FIG. 2 shows the XRD pattern of the low-crystalline MOF aggregate layer prepared in Example 1;

FIG. 3 shows the SEM image of the Al-bttotb membrane prepared in Example 1;

FIG. 4 shows the XRD pattern of the Al-bttotb film prepared in Example 1;

FIG. 5 shows the separation performance of the Al-bttotb membrane prepared in Example 1;

FIG. 6 shows the SEM image of the oriented Al-bttotb membrane prepared in Example 2;

FIG. 7 shows the XRD pattern of the oriented Al-bttotb membrane prepared in Example 2;

FIG. 8 shows the separation performance diagram of the oriented Al-bttotb membrane prepared in Example 2;

FIG. 9 shows the SEM image of the tubular alumina-supported Al-bttotb membrane prepared in Example 3;

FIG. 10 shows the SEM image of the PVDF-supported Al-bttotb membrane prepared in Example 4;

FIG. 11 shows the SEM image of the MIL-53 membrane prepared in Example 5;

FIG. 12 shows the XRD pattern of the MIL-53 membrane prepared in Example 5;

FIG. 13 shows the separation performance diagram of the MIL-53 membrane prepared in Example 5;

FIG. 14 shows the SEM image of the MIL-160 membrane prepared in Example 6;

FIG. 15 shows the XRD pattern of the MIL-160 membrane prepared in Example 6;

FIG. 16 shows the separation performance diagram of the MIL-160 membrane prepared in Example 6;

FIG. 17 shows the SEM image of the CAU-10-H membrane prepared in Example 7;

FIG. 18 shows the XRD pattern of the CAU-10-H membrane prepared in Example 7;

FIG. 19 shows the separation performance diagram of the CAU-10-H membrane prepared in Example 7;

FIG. 20 shows the SEM image of the KMF-1 membrane prepared in Example 8;

FIG. 21 shows the separation performance diagram of the KMF-1 membrane prepared in Example 8;

FIG. 22 shows the SEM image of the AL-Fum membrane prepared in Example 9;

FIG. 23 shows the XRD pattern of the AL-Fum membrane prepared in Example 9;

FIG. 24 shows the separation performance diagram of the AL-Fum membrane prepared in Example 9;

FIG. 25 is the SEM image of the low-crystalline MOF aggregate layer prepared in Comparative Example 1;

FIGS. 26-27 show the SEM images of the membrane prepared in Comparative Example 1;

FIGS. 28-30 are SEM images showing the low-crystalline growth and membrane growth of Comparative Example 2.

FIGS. 31-32 are SEM images of the membrane prepared in Comparative Example 3.

### SPECIFIC IMPLEMENTATION METHODS

The technical solutions of the present invention will be described in detail below in conjunction with specific examples, so that those skilled in the art can better understand and implement the technical solutions of the present invention, but this does not limit the present invention to the scope of the examples described.

### Example 1

This example provides an Al-bttotb membrane prepared by the low-crystalline aggregate induction method, and its preparation steps are specifically as follows:
(1) A porous sheet-shaped alumina support (with a pore size of 200 nm) was polished with 600-mesh and 1200-mesh sandpapers for 5 minutes respectively, then placed in a methanol solution for ultrasonic cleaning for 15 minutes at an ultrasonic frequency of 50 KHz, and subsequently heat-treated in a vacuum drying oven at 150° C. for 2 hours. After that, it was taken out and sealed for later use.
(2) Al-bttotb nanoparticles (with a particle size of 150 nm) were prepared by combining the solvothermal method and mechanical ball milling method, specifically as follows: Metals and ligands were added into a mixed solvent of DMF/water/formic acid (15/5/1 mL), stirred at room temperature for 30 minutes, then transferred to a 100 mL polytetrafluoroethylene reaction kettle, which was subsequently moved into an oven pre-set at 150° C. for 1 day. After the reaction was cooled to room temperature, white crystals were obtained. These white crystals were rod-shaped crystals with a size of 10-20 μm. Then 1.5 g of the rod-shaped crystals and 47 g of agate grinding balls were added into a ball milling tank, and the vertical planetary ball mill XQM-12 was used to run at a rotating speed of 400 rpm for 240 minutes. The ball-milled product was subjected to a differential centrifugation procedure at 7000 rpm to collect spherical crystals with a particle size of about 150 nm. Subsequently, the previously prepared Al-bttotb nanoparticles were dispersed in a methanol solution to obtain a seed dispersion, in which the mass fraction of Al-bttotb nanoparticles was 0.015 wt. %.
(3) The aforementioned seed dispersion was coated on the porous alumina support by means of hot drop coating, specifically: the support was preheated to 80° C., then 1 mL of the seed dispersion was transferred to the polished side of the support using a 1 mL pipette. After drying for 30 seconds, the above operation was repeated 3 times, and a uniform seed layer was obtained on the surface of the support.
(4) Take 0.4 g of aluminum chloride, 0.6 g of 4,4′,4″-(phenyl-1,3,5-trioxo)-benzoic acid and 0.8 g of formic acid, dissolve them in 20 mL of DMF solvent to prepare a supersaturated solution. Transfer the supersaturated solution into a polytetrafluoroethylene reaction kettle (volume ˜50 mL), then vertically place the support with deposited Al-bttotb nanoseeds in it, and react at 100° C. for 1 hour, so that the nanoseed layer can be converted into a continuous low-crystalline MOF aggregate layer.
(5) The support with the low-crystalline MOF aggregate layer grown thereon was vertically placed in a polytetrafluoroethylene reaction kettle (volume ˜50 mL), and subjected to a high-temperature reaction at 150° C. for 3 hours, so that the low-crystalline structure could be converted into an Al-bttotb membrane with a highly ordered crystal lattice.

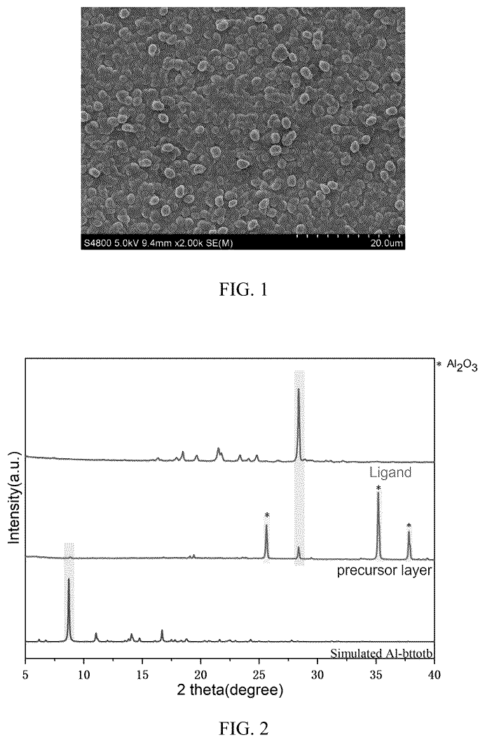

The low-crystalline MOF aggregate layer prepared in step (4) was tested by scanning electron microscopy (SEM) and powder X-ray diffraction (XRD), and the results are shown in FIGS. 1 and 2 respectively. In FIG. 2, the precursor layer corresponds to the support carrier containing the low-crystalline MOF aggregate layer. It can be seen that a continuous low-crystalline MOF aggregate layer is formed on the surface of the porous alumina support, with a thickness of about 2 μm.

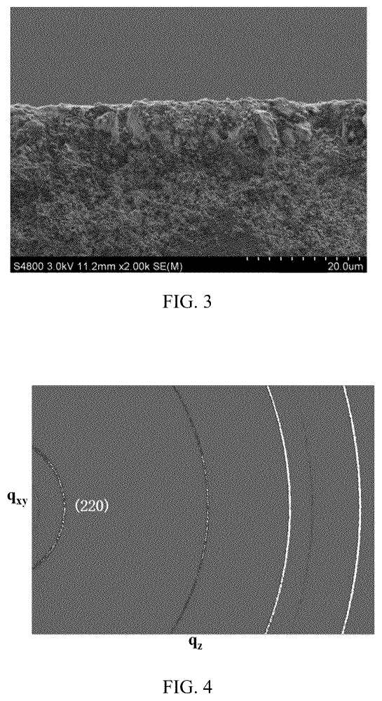

The Al-bttotb membrane prepared in step (5) was tested by scanning electron microscopy (SEM) and powder X-ray diffraction (XRD, 2D-XRD), with the results shown in FIGS. 3 and 4 respectively. It can be seen that a high-quality Al-bttotb membrane was successfully prepared on the porous support, with continuous surface and cross-section, no grain boundary defects, and a thickness of about 10 μm.

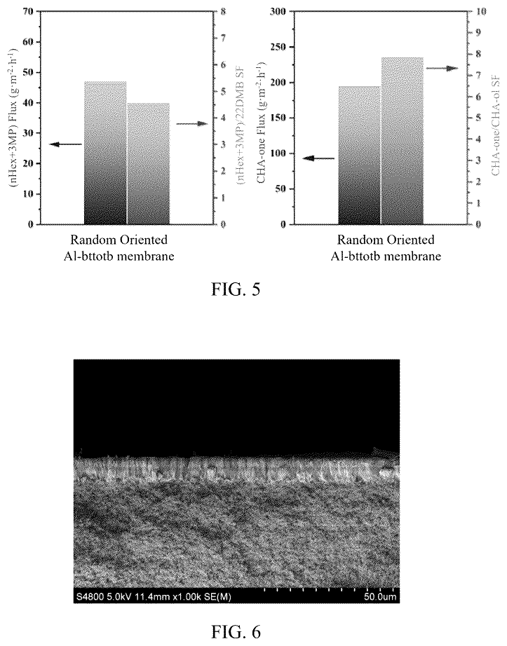

The aforementioned Al-bttotb membrane was subjected to pervaporation separation testing, and the results are shown in FIG. 5 (where nHex represents n-hexane, 3MP represents 3-methylpentane, and 22DMB represents 2,2-dimethylbutane). It can be seen that the membrane can efficiently separate both the three-component system of hexane isomers and the cyclohexanone/cyclohexanol system. n-hexane and 3-methylpentane can permeate through the membrane, while 2,2-dimethylbutane cannot. The membrane exhibits excellent permeation selectivity for n-hexane, 3-methylpentane, and cyclohexanone, respectively.

### Example 2

This example provides an oriented Al-bttotb membrane, whose preparation steps are basically the same as those in Example 1, with the only differences being: the porous alumina support after polishing in step (1) is subjected to surface chemical modification to adjust its surface property from hydrophilic to lipophilic. The specific operation is as follows: immerse the alumina support in a n-heptane solution containing 2wt. % dimethyldichlorosilane, react at room temperature for 2 hours, then take out the alumina support and clean it with deionized water for 3 times, and set it aside for later use. In addition, water is introduced as a co-solvent into the supersaturated solution in step (4), where the volume ratio of DMF to water is 3:1, and the total volume of the two is still 20 mL. Finally, a highly c-axis oriented Al-bttotb membrane is obtained.

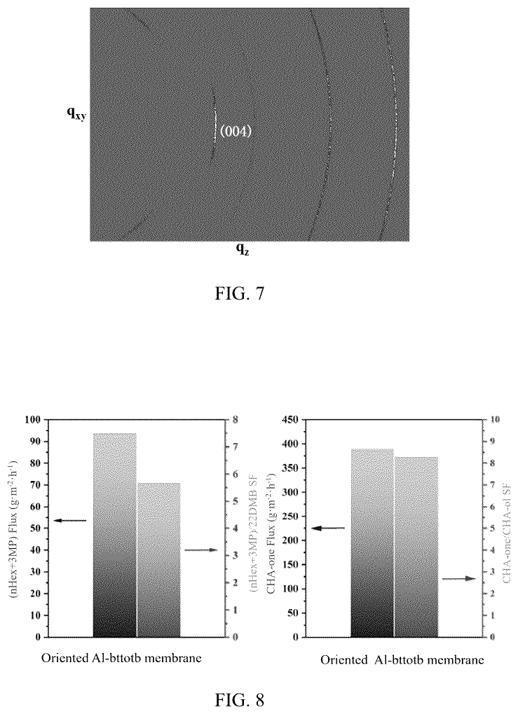

The highly c-axis oriented Al-bttotb membrane was tested by scanning electron microscopy (SEM) and powder X-ray diffraction (XRD), with the results shown in FIGS. 6 and 7 respectively. It can be seen that a continuous, dense Al-bttotb membrane with highly 1D channel orientation was successfully prepared on the porous support, with a thickness of about 10 μm.

The aforementioned oriented Al-bttotb membrane was subjected to pervaporation separation testing, and the results are shown in FIG. 8. It can be seen that the separation performance of this membrane for both the three-component system of hexane isomers and the cyclohexanone/cyclohexanol system has doubled compared with the randomly oriented membrane in Example 1, especially the permeation flux of n-hexane and cyclohexanone.

### Example 3

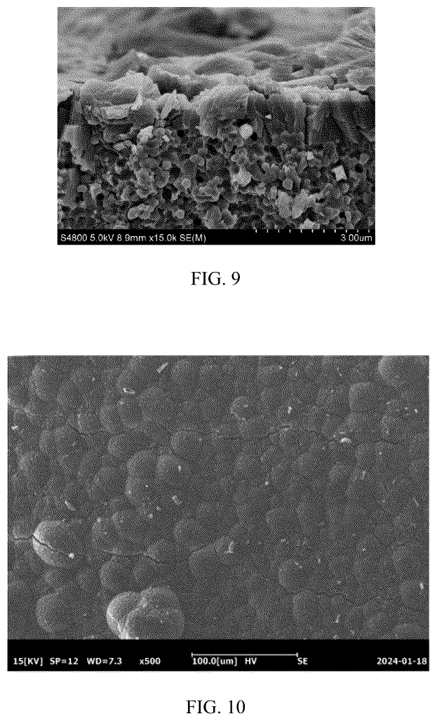

This example provides an Al-bttotb membrane, whose preparation steps are basically the same as those in Example 1, with the only difference being that the porous sheet-shaped alumina support is replaced with a porous tubular alumina support. The SEM image of the finally obtained membrane is shown in FIG. 9. It can be seen that a high-quality continuous Al-bttotb membrane is successfully prepared, indicating that the method of the present application can be applied to various support carriers and has universality.

### Example 4

This example provides an Al-bttotb membrane, whose preparation steps are basically the same as those in Example 1, with the only difference being that the porous sheet-shaped alumina support is replaced with a porous PVDF support. The SEM image of the finally obtained membrane is shown in FIG. 10. It can be seen that a high-quality continuous Al-bttotb membrane is successfully prepared, indicating that the method of the present application can be applied to various support carriers and has universality.

### Example 5

This example provides a MIL-53 membrane prepared by the low-crystalline aggregate induction method, and its preparation steps are specifically as follows:
(1) Same as Example 1;
(2) Nanoscale MIL-53 particles with a particle size of 150 nm were prepared by the solvothermal method combined with mechanical ball milling; then the seed dispersion was prepared in the same manner as in Example 1.
(3) Same as Example 1;
(4) Take 0.4 g of aluminum nitrate nonahydrate, 0.6 g of 1,4-benzenedicarboxylic acid and 0.8 g of benzoic acid, dissolve them in 20 mL of DMF solvent to prepare a supersaturated solution. Transfer the supersaturated solution into a polytetrafluoroethylene reaction kettle (volume ˜50 mL), then vertically place the support with deposited MIL-53 nanoseeds in it, and react at 150° C. for 1 hour, so that the nanoseed layer can be converted into a continuous low-crystalline MOF aggregate layer.
(5) The support with the grown low-crystalline MOF aggregate layer was vertically placed into a polytetrafluoroethylene reaction kettle (with a volume of ˜50 mL), and subjected to a high-temperature reaction at 200° C. for 3 hours, thus converting the low-crystalline structure into a MIL-53 membrane with a highly ordered crystal lattice.

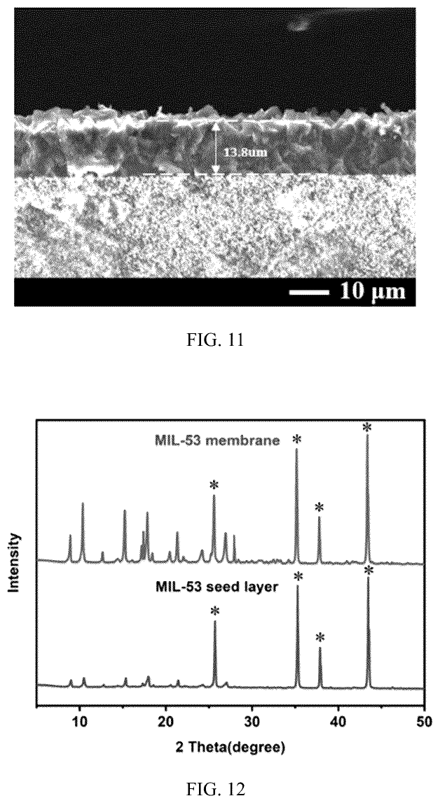

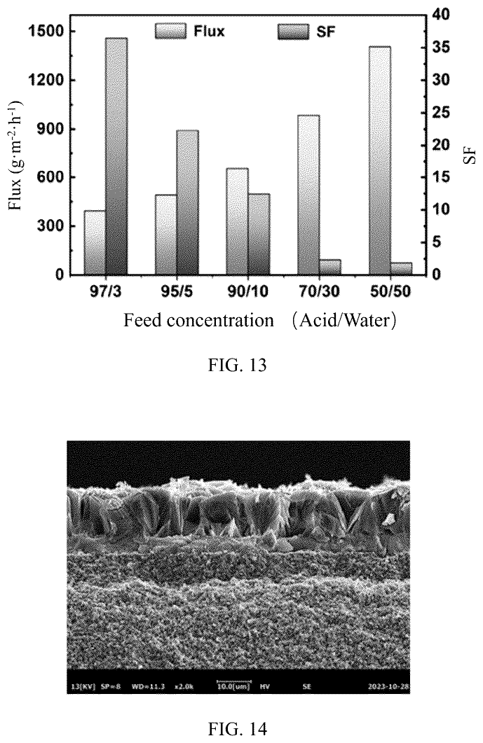

The SEM image (FIG. 11) and XRD pattern (FIG. 12) of the MIL-53 membrane confirm the successful preparation of a high-quality MIL-53 membrane with a thickness of approximately 13.8 μm. The pervaporation separation test of this membrane (FIG. 13, where Flux refers to flux, SF refers to separation factor, and the feed concentration is the mass ratio of acetic acid to water) shows that the membrane can separate the acetic acid/water system and exhibits excellent acetic acid permeation selectivity and permeability.

### Example 6

This example provides a MIL-160 membrane prepared by a low-crystallinity aggregate induction method, and its preparation steps are as follows:
(1) Same as Example 1.
(2) Nanoscale MIL-160 particles with a particle size of 150 nm are prepared by solvothermal method and mechanical ball milling method; then the seed dispersion is prepared in the same way as in Example 1.
(3) Same as Example 1.
(4) Take 0.4 g of aluminum chloride, 0.6 g of 2,5-furandicarboxylic acid and 0.8 g of sodium formate, dissolve them in 20 mL of DMF/water mixed solvent (with a volume ratio of 3:1) to prepare a supersaturated solution. Transfer the supersaturated solution to a polytetrafluoroethylene (volume ˜50 mL) reaction kettle, then vertically place the support with deposited MIL-160 nano-seeds in it, and react at 100° C. for 1 hour to convert the nano-seed layer into a continuous low-crystalline MOF aggregate layer.
(5) Vertically place the support with the grown low-crystalline MOF aggregate layer into a polytetrafluoroethylene (volume ˜50 mL) reaction kettle, and conduct a high-temperature reaction at 100° C. for 3 hours, so that the low-crystalline structure can be converted into a MIL-160 membrane with a highly ordered crystal lattice.

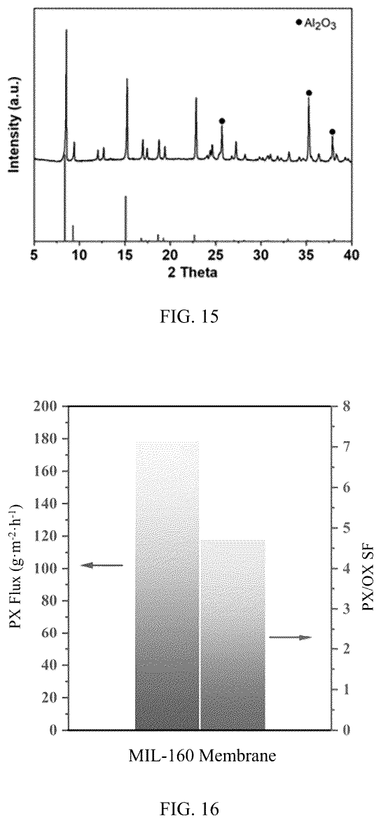

The SEM image (FIG. 14) and XRD pattern (FIG. 15) of the membrane confirm the successful preparation of a high-quality MIL-160 membrane with a thickness of approximately 30 μm. The pervaporation separation test of the membrane (FIG. 16) shows that the membrane can separate xylene isomer systems, exhibiting excellent p-xylene permeation selectivity and permeability.

### Example 7

This example provides a CAU-10-H membrane prepared by the low-crystalline aggregate induction method, with its specific preparation steps as follows:
(1) Same as Example 1.
(2) Nanoscale CAU-10-H particles with a particle size of 50 nm are prepared by the solvothermal method; then the seed dispersion is prepared in the same manner as in Example 1.
(3) Same as Example 1.
(4) Take 0.4 g of aluminum sulfate, 0.6 g of isophthalic acid and 0.8 g of sodium hydroxide, dissolve them in 20 mL of water to prepare a supersaturated solution. Transfer the supersaturated solution to a polytetrafluoroethylene (volume ˜50 mL) reaction kettle, then vertically place the support with deposited CAU-10-H nano-seeds in it, and react at 100° C. for 1 hour to convert the nano-seed layer into a continuous low-crystalline MOF aggregate layer.
(5) Vertically place the support with the grown low-crystalline MOF aggregate layer into a polytetrafluoroethylene (volume ˜50 mL) reaction kettle, and conduct a high-temperature reaction at 100° C. for 3 hours, which will convert the low-crystalline structure into a CAU-10-H membrane with a highly ordered crystal lattice.

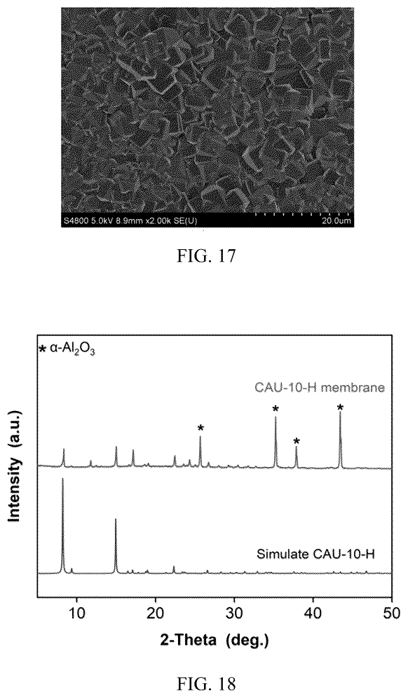

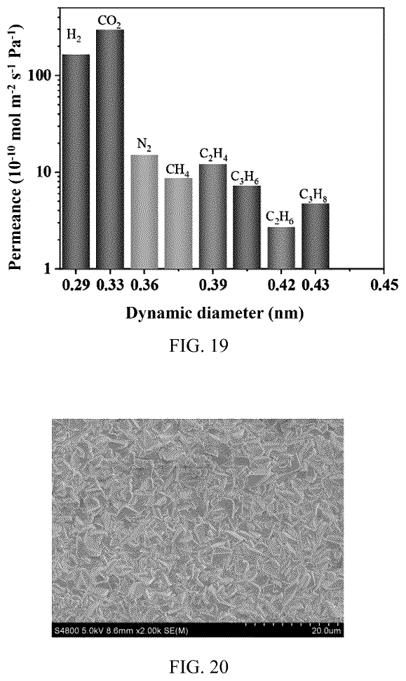

The SEM image (FIG. 17) and XRD pattern (FIG. 18) of the membrane confirm the successful preparation of a high-quality CAU-10-H membrane. The pervaporation separation test of the membrane (FIG. 19) shows that the membrane can separate carbon dioxide/methane, carbon dioxide/nitrogen and ethylene/ethane systems, exhibiting excellent separation selectivity. Among them, Fuli, Haerpu and Shimadzu respectively refer to the corresponding components tested by the detection instruments of the corresponding manufacturers.

### Example 8

This example provides a KMF-1 membrane prepared by the low-crystalline aggregate induction method, with its specific preparation steps as follows:
(1) Same as Example 1.
(2) Nanoscale KMF-1 particles with a particle size of 100 nm are prepared by the solvothermal method; then the seed dispersion is prepared in the same way as in Example 1.
(3) Same as Example 1.
(4) Take 0.4 g of aluminum chloride, 0.6 g of 2,5-pyrroledicarboxylic acid and 0.8 g of sodium hydroxide, dissolve them in 20 ml of water to prepare a supersaturated solution. Transfer the supersaturated solution to a polytetrafluoroethylene (volume ˜50 mL) reaction kettle, then vertically place the support with deposited KMF-1 nano-seeds in it, and react at 80° C. for 1 hour to convert the nano-seed layer into a continuous low-crystalline MOF aggregate layer.
(5) Vertically place the support with the grown low-crystalline MOF aggregate layer into a polytetrafluoroethylene (volume ˜50 mL) reaction kettle, and conduct a high-temperature reaction at 80° C. for 3 hours, which will convert the low-crystalline structure into a KMF-1 membrane with a highly ordered crystal lattice.

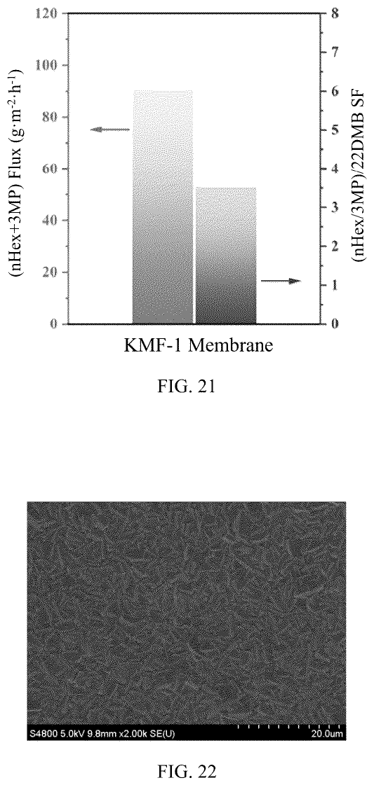

The SEM image (FIG. 20) of the membrane confirms the successful preparation of a high-quality KMF-1 membrane. The pervaporation separation test of the membrane (FIG. 21) shows that the membrane can separate hexane isomer systems, exhibiting excellent separation selectivity.

### Example 9

This example provides an Al-fum membrane prepared by the low-crystalline aggregate induction method, with its specific preparation steps as follows:
(1) Same as Example 1.
(2) Nanoscale Al-fum particles with a particle size of 100 nm are prepared by the solvothermal method; then the seed dispersion is prepared in the same way as in Example 1.
(3) Same as Example 1.
(4) Take 0.4 g of sodium metaaluminate, 0.6 g of fumaric acid and 0.8 g of sodium acetate, dissolve them in 20 mL of DMF/water mixed solvent (with a volume ratio of 3:1) to prepare a supersaturated solution. Transfer the supersaturated solution to a polytetrafluoroethylene (volume ˜50 mL) reaction kettle, then vertically place the support with deposited Al-fum nano-seeds in it, and react at 120° C. for 1 hour to convert the nano-seed layer into a continuous low-crystalline MOF aggregate layer.
(5) Vertically place the support with the grown low-crystalline MOF aggregate layer into a polytetrafluoroethylene (volume ˜50 mL) reaction kettle, and conduct a high-temperature reaction at 100° C. for 3 hours, which will convert the low-crystalline structure into an Al-fum membrane with a highly ordered crystal lattice.

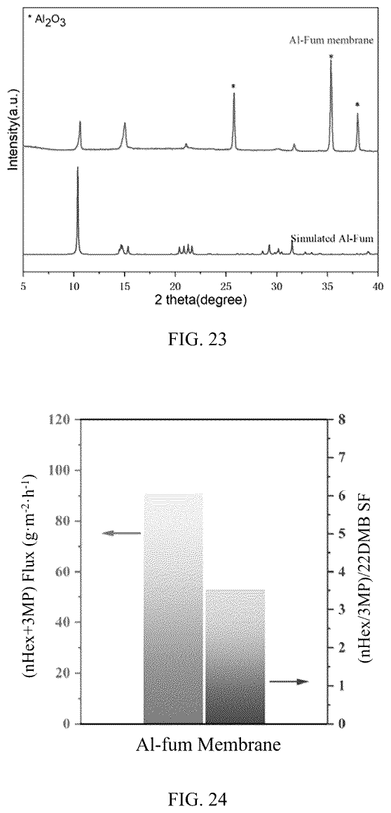

The SEM image (FIG. 22) and XRD pattern (FIG. 23) of the membrane confirm the successful preparation of a high-quality Al-fum membrane with a thickness of approximately 10 μm. The pervaporation separation test of the membrane (FIG. 24) shows that the membrane can separate hexane isomer systems, exhibiting excellent n-hexane separation selectivity.

### Comparative Example 1

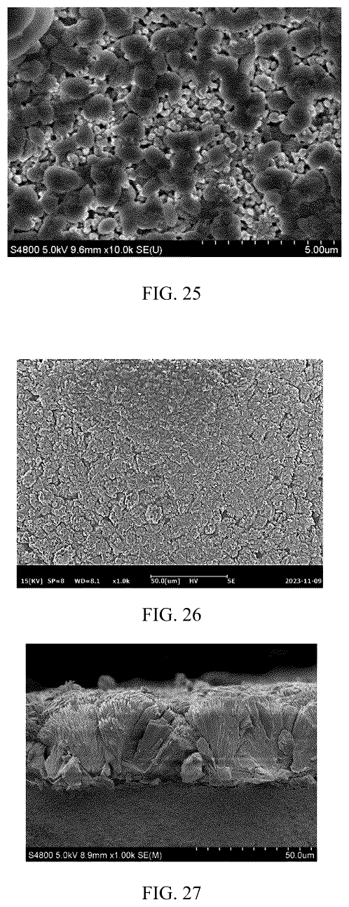

It is basically the same as Example 1, with the only difference being that in step (4), 0.4 g of aluminum chloride, 0.6 g of 4,4′,4″-(phenyl 1,3,5-trioxo)-benzoic acid and 0.8 g of formic acid are replaced with 0.08 g of aluminum chloride, 0.06 g of 4,4′,4″-(phenyl 1,3,5-trioxo)-benzoic acid and 0.8 g of formic acid respectively, and the prepared solution is unsaturated. Scanning electron microscopy (SEM) tests were performed on the prepared low-crystalline MOF aggregates and Al-bttotb membrane, and the results are shown in FIGS. 25-27. The low-crystalline Al-MOF aggregates appear discontinuous on the surface of the porous support (FIG. 25), and the membrane converted therefrom also has obvious grain boundary defects (FIGS. 26-27).

### Comparative Example 2

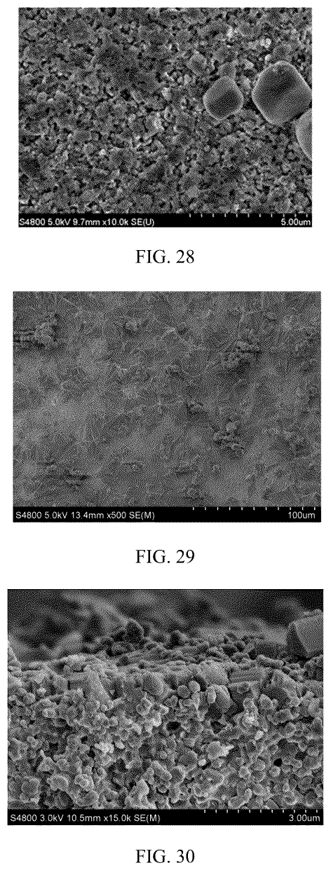

It is basically the same as Example 1, with the only difference being that no formic acid is added in step (4), that is, no coordination regulator is added to the supersaturated solution. Scanning electron microscopy (SEM) tests were conducted on the low-crystalline growth and membrane growth conditions, and the results are shown in the figures (FIGS. 28-30). It can be seen that no low-crystalline Al-MOF aggregates were obtained on the surface of the porous support (FIG. 28), so it cannot be used to convert into an Al-bttotb membrane with a highly ordered crystal lattice (FIGS. 29-30)

### Comparative Example 3

Using porous alumina as the support, the Al-bttotb membrane was prepared by the conventional secondary seed growth method.

Steps (1)-(3): Same as in Example 1;

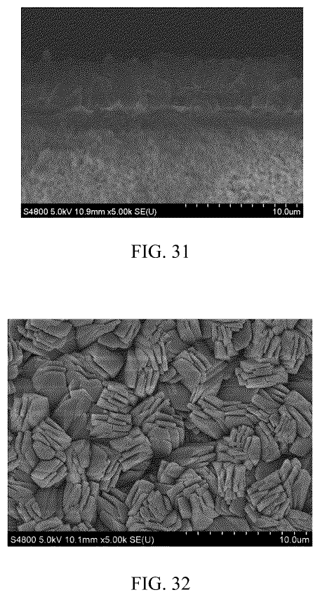

Step (4): Prepare a reaction solution with 0.08 g of aluminum chloride, 0.12 g of 4,4′,4″-(phenyl-1,3,5-trioxo)-benzoic acid and 0.8 g of formic acid. Transfer the reaction solution to a polytetrafluoroethylene (volume ˜50 mL) reaction kettle, directly place the support with deposited Al-bttotb nano-seeds vertically in it, and react at 150° C. for 12 hours. Scanning electron microscopy (SEM) tests were performed on the prepared Al-bttotb membrane, and the results are shown in FIGS. 31-32. It can be seen that a continuous Al-bttotb membrane layer is obtained, but there are excessive intergranular gaps and irregular morphology.

The above examples are only intended to illustrate the technical concept and characteristics of the present invention, and their purpose is to enable those familiar with this technology to understand the content of the present invention and implement it accordingly, but they cannot limit the protection scope of the present invention. All equivalent changes or modifications made in accordance with the spiritual essence of the present invention shall be covered within the protection scope of the present invention.

1. A method for preparing an Al-MOF membrane material, wherein the preparation method comprises the following steps: 1) depositing Al-MOF seeds on the surface of a porous support to obtain an Al-MOF seed layer; 2) placing the porous support with the Al-MOF seed layer deposited on its surface in a supersaturated solution for reaction to grow a continuous low-crystal Al-MOF aggregate layer on the surface of the porous support; 3) performing a crystallization reaction on the porous support with the continuous low-crystal Al-MOF aggregate layer grown on its surface to obtain the Al-MOF membrane material; the supersaturated solution includes aluminum salt, ligand and coordination regulator.

2. The method for preparing an Al-MOF membrane material according to claim 1, wherein: the aluminum salt is selected from one or a combination of more than one of aluminum nitrate, aluminum isopropoxide, sodium metaaluminate, aluminum chloride, aluminum acetate, polyaluminum chloride and aluminum sulfate octadecahydrate; and/or, the ligand is a carboxylic acid ligand, preferably, the ligand is selected from one or a combination of more than one of 4,4′,4″-(phenyl-1,3,5-trioxo)benzoic acid, 1,4-benzenedicarboxylic acid, isophthalic acid, 2,5-furandicarboxylic acid, 2,5-pyrroledicarboxylic acid and fumaric acid; and/or, the coordination regulator is selected from acidic coordination regulators or basic coordination regulators, preferably, the acidic coordination regulator is selected from one or a combination of more than one of formic acid, acetic acid, benzoic acid and o-fluorobenzoic acid; the basic coordination regulator is selected from one or a combination of more than one of sodium hydroxide, sodium formate and sodium acetate.

3. The method for preparing an Al-MOF membrane material according to claim 1, wherein: the total mass of the aluminum salt and ligand accounts for 4%-20% of the mass of the supersaturated solution; and/or, in the supersaturated solution, the mass ratio of the aluminum salt to the ligand is 1:1 to 1.5; and/or, the mass of the coordination regulator accounts for 1%-5% of the mass of the supersaturated solution; and/or, the solvent of the supersaturated solution is selected from one or a combination of two of DMF and water.

4. The method for preparing an Al-MOF membrane material according to claim 1, wherein: the preparation method further includes a step of preparing the supersaturated solution: dissolving the aluminum salt in a solvent, adding the ligand and the coordination regulator to the solvent, and stirring at room temperature to obtain the supersaturated solution.

5. The method for preparing an Al-MOF membrane material according to claim 1, wherein: the thickness of the low-crystallinity Al-MOF aggregate layer is 1-3 μm.

6. The method for preparing an Al-MOF membrane material according to claim 1, wherein: the reaction in step 2) is carried out at 80-150° C.; and/or, the reaction time in step 2) is 0.5-2 hours; and/or, the reaction in step 2) is performed in a closed reactor.

7. The method for preparing an Al-MOF membrane material according to claim 1, wherein: the crystallization reaction in step 3) is carried out at 80-150° C.; and/or, the duration of the crystallization reaction in step 3) is 3-10 hours; and/or, the crystallization reaction in step 3) is conducted in a closed reactor.

8. The method for preparing an Al-MOF membrane material according to claim 1, wherein: the Al-MOF seeds are the same as the Al-MOF crystals in the Al-MOF membrane material, or the Al-MOF seeds have the same topological structure as the Al-MOF crystals in the Al-MOF membrane material; and/or, the particle size of the Al-MOF seeds is 50-300 nm; and/or, the deposition in step 1) is achieved by a thermal drop-coating method, spin-coating method, vacuum filtration method or slip-coating method, wherein the thermal drop-coating method includes the steps of preheating the porous support and drop-coating; and/or, the thickness of the Al-MOF seed layer is 0.5-5 μm.

9. The method for preparing an Al-MOF membrane material according to claim 1, wherein: the Al-MOF seeds are prepared by one or a combination of two methods selected from solvothermal method and mechanical ball milling method; and/or, the preparation method further includes the steps of polishing or ultrasonically cleaning the porous support and drying it before depositing the Al-MOF seeds.

10. The method for preparing an Al-MOF membrane material according to claim 1, wherein: the porous support is selected from a porous alumina carrier or a porous polymer support; preferably, the pore size of the porous alumina carrier is 100-300 nm, and the porous alumina carrier is in a plate, tube or hollow fiber form; the material of the porous polymer support is selected from nylon, polyacrylonitrile, polydimethylsiloxane, polyethersulfone or polyvinylidene fluoride.

11. The method for preparing an Al-MOF membrane material according to claim 1, wherein: the Al-MOF is selected from one or a combination of more than one of Al-bttotb, MIL-53, CAU-10-H, CAU-23, MIL-160, KMF-1 and Al-fum.

12. An Al-MOF membrane material prepared by the preparation method according to claim 1.

13. A separation device, used for the separation of carbon dioxide/methane, carbon dioxide/nitrogen, ethylene/ethane, hexane isomers, cyclohexanol/cyclohexanone, xylene isomers, and acetic acid/water, wherein: the separation device comprises the Al-MOF membrane material according to claim 12.

14. (canceled)

15. (canceled)
